(19) United States
(12) Patent Application Publication
(10) Pub. No.: US 2011/0157192 A1
(43) Pub. Date: Jun. 30, 2011

(54) Parallel Block Compression With a GPU

(75) Inventors: Minmin Gong, Beijing (CN); Jiaping Wang, Beijing (CN); Peiran Ren, Beijing (CN)

(73) Assignee: Microsoft Corporation, Redmond, WA (US)

(21) Appl. No.: 12/648,699

(22) Filed: Dec. 29, 2009

(51) Int. Cl. G06K 9/36; G06F 15/80; G06K 9/46

(52) U.S. Cl. 345/505; 382/244; 382/243

(57) ABSTRACT

Disclosed is a system and method for determining, in parallel on a graphics processing unit, a block compression case which results in a least error to a block. Once determined, the block compression case may be used to compress the block.

### BACKGROUND

Images generated, manipulated, displayed, and so forth by computing devices traditionally comprise pixels. Pixels may be grouped into blocks for convenience in processing. These blocks may then be manipulated in graphics systems for processing, storage, display, and so forth. As the size and complexity of images has increased, so too have the computational and memory demands placed on devices which manipulate those images.

To reduce the amount of memory required to store data about a pixel, block compression may be used. Block compression is a technique for reducing the amount of memory required to store color or other pixel-related data. By storing some colors or other pixel data using an encoding scheme, the amount of memory required to store the image may be dramatically reduced. Thus, reduction in the size the overall data permits easier storage and manipulation by a processor.

Often block compression techniques involve lossy compression. Lossy compression offers speed and high compression ratios, but results in image degradation due to the information loss. Each block may have a plurality of “cases,” that is, possible ways to encode the block.

Furthermore, not all of the cases result in desirable compression results. Some cases may result in a large deviation from the original image, while other cases may result in less deviation. Those cases which result in less deviation more accurately reproduce the original image, and are thus preferred by users.

Traditionally, determining which case introduces the least error into the block during block compression has been time and processor intensive. Given the demand for higher speed graphics systems to support commercial, medical, and research applications, there is a need for highly efficient block compression.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed is a system and method for determining, in parallel on a graphics processing unit (GPU), which block compression case results in the least error to a block. This error may also be considered the variance between the original block and the compressed block. Once determined, the case resulting in the least error to the block may be used to compress the block. Use of multiple cores in a multi-core graphics processor allows the evaluation of several block cases in parallel, resulting in short processing times.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram of an illustrative architecture usable to implement parallel block compression with a GPU.

FIG. 2 is a schematic illustrating the relationship between an image, a plurality of blocks, and compression cases associated with each block.

FIG. 3 is a flow diagram of an illustrative process of parallel block compression with a GPU.

FIG. 4 is a flow diagram of an illustrative process of parallel reduction of cases to determine a case having the least error.

FIG. 5 is a flow diagram of an illustrative process of optimizing endpoints in a block.

### DETAILED DESCRIPTION

This disclosure describes determining, in parallel on a graphics processing unit (GPU), a block compression case which results in a least error to a pixel block. A block compression case is one mode of compressing a pixel block. Each pixel block (or “block”) may have a plurality of possible modes, thus a plurality of possible compression cases. Block compression cases are evaluated to determine which provides the least error compared to the original block.

Once determined, that case resulting in the least error to the block may be used to compress the block. As a result, the block compression chosen to compress the block introduces the least possible degradation to the original image. This process is facilitated by the use of multiple cores in a graphics processing unit (GPU), which allows the evaluation of each block case in parallel. This ability to process in parallel leads to speed increases in image encoding over block compression executing solely on a central processing unit (CPU).

### Illustrative Architecture

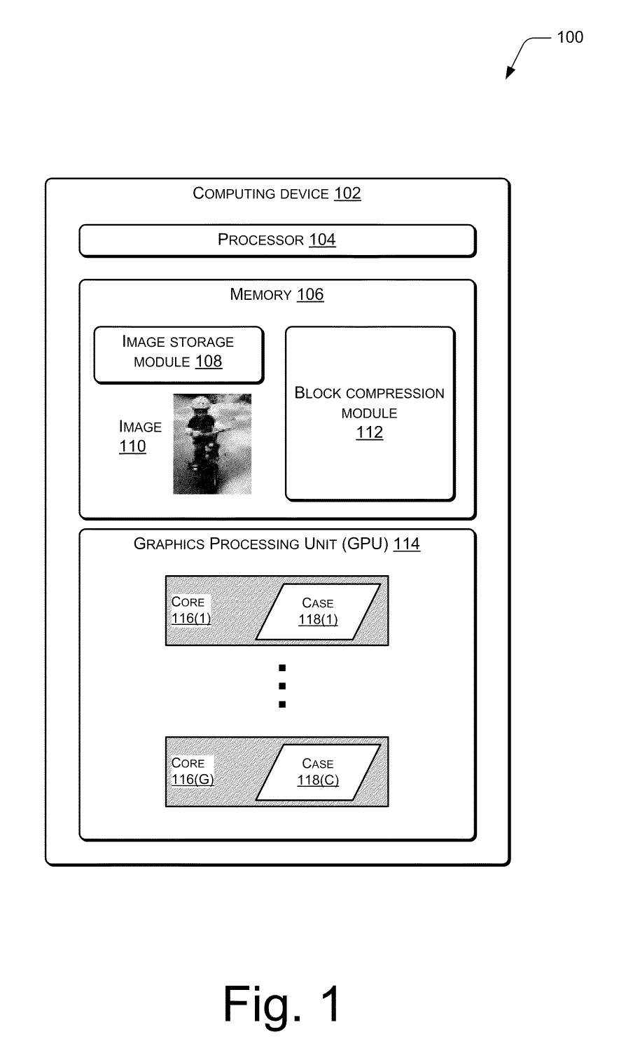

FIG. 1 is a block diagram of an illustrative architecture 100 usable to implement parallel block compression with a GPU. A computing device 102, such as a laptop, cellphone, portable media player, netbook, server, electronic book reader, and so forth, is shown. Within computing device 102 may be a processor 104 comprising a central processing unit (CPU). Also within computing device 102 and coupled to the processor 104 is a memory 106. As used in this application, “coupled” indicates a communication pathway which may or may not be a physical connection. Memory 106 may be any computer readable storage media such as random access memory, read only memory, magnetic storage, optical storage, flash memory, and so forth. Stored within memory 106 may be an image storage module 108, configured to execute on processor 104. Image storage module 108 may be configured to store and retrieve images in memory 106. Also shown, within memory 106, is an image 110. Image 110 may comprise pixels and other graphic elements such as texture, shading, and so forth. Also within memory 106 is a block compression module 112, configured to execute on processor 102 and compress images stored in memory 106, such as image 110. In some implementations, images may only be stored partly in memory 106, for example during streaming or successive transfer of image data into memory.

Computing device 102 may also incorporate a graphics processing unit (GPU) 114, which is coupled to processor 104 and memory 106. GPU 114 may comprise multiple processing cores 116(1), . . . , 116(G). As used in this application, letters within parentheses, such as “(C)” or “(G)”, denote any integer number greater than zero. Block compression module 112 executes cases 118(1), . . . , 118(C) in cores 116(1)-(G) of GPU 114. By way of illustration, and not as a limitation, as shown here a single case 118 is executed on each core 116. In other implementations, a plurality of cases 118 may be loaded into a single core 116. In addition to GPUs, other multi-core processing devices may be used to execute the cases 118(1)-(C).

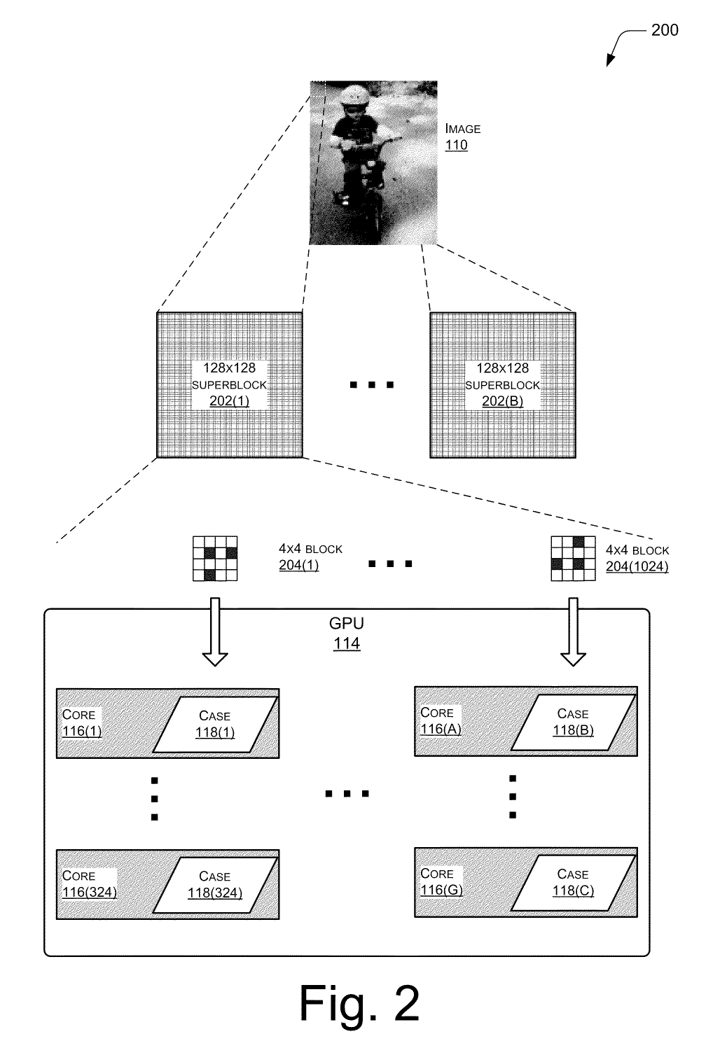

FIG. 2 is a schematic 200 illustrating the relationship between an image, a plurality of blocks, and the cases associated with each block. Image 110 comprises a plurality of pixels. These pixels may be arranged into superblocks 202(1), . . . , 202(B) which, together, form image 110. Each superblock 202 comprises an array of pixels, for example 128×128 pixels, which may be further decomposed into a plurality of blocks. For several reasons including ease of processing and industry tradition, these blocks are typically 4×4 pixel blocks 204, however the pixel blocks 202 may be different sizes. By way of illustration and not as a limitation, given the size of the 128×128 superblock 202, each superblock 202 may be subdivided into 1,024 of the 4×4 blocks 204(1), . . . , 204(1024). In other implementations using different superblock sizes, the number of 4×4 blocks may vary. Similarly, in other implementations blocks may be sizes other than 4×4.

To reduce memory and processing requirements, blocks may be compressed using block compression. Block compression may provide a plurality of possible ways, or “cases” to partition and encode each block 204. For example, “block compression 6” (BC6) provided by Microsoft® of Redmond, Wash. is suitable for encoding high dynamic range (HDR) textures and provides 324 cases for each block. As an example, and not by way of limitation, the following examples assume BC6 encoding with 324 cases per block. It is understood that others forms of block compression including BC7 which is used for encoding low dynamic range (LDR) textures, as well as BC1, BC2, BC3, BC4, and BC5 may be used.

As shown in FIG. 2, cases 118(1)-(324) are loaded and executed on cores 116(1)-(324) within GPU 114. Given the cores 116(1)-(G) are able to execute in parallel on GPU 114, this allows all 324 of the possible cases for the 4×4 block 204(1) to be processed simultaneously. Similarly, additional 4×4 blocks 204(2)-(1024) may be processed on additional cores 116(A)-(G). For example, where cores 116(1)-(648) are available, cases for two complete 4×4 blocks 204 could be processed in parallel.

### Illustrative Parallel Block Compression

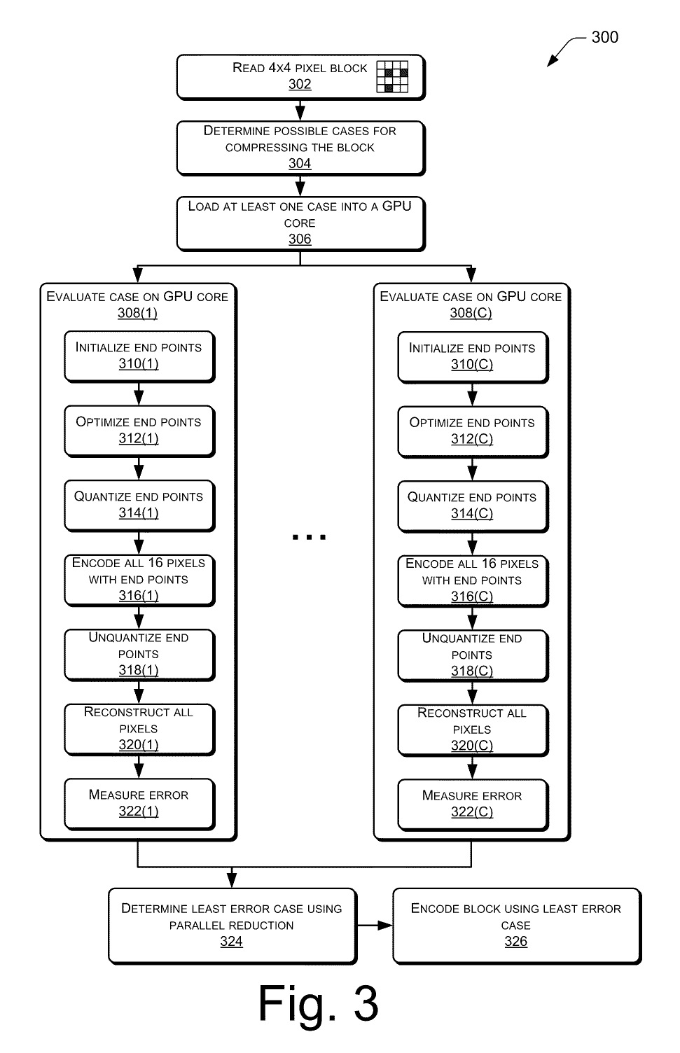

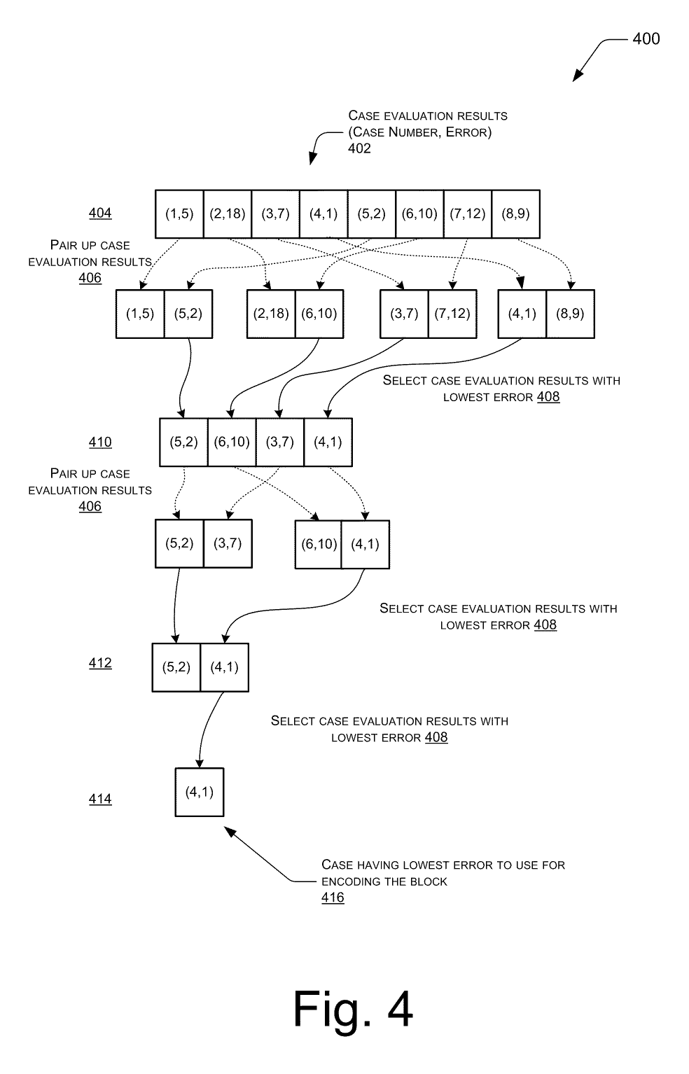

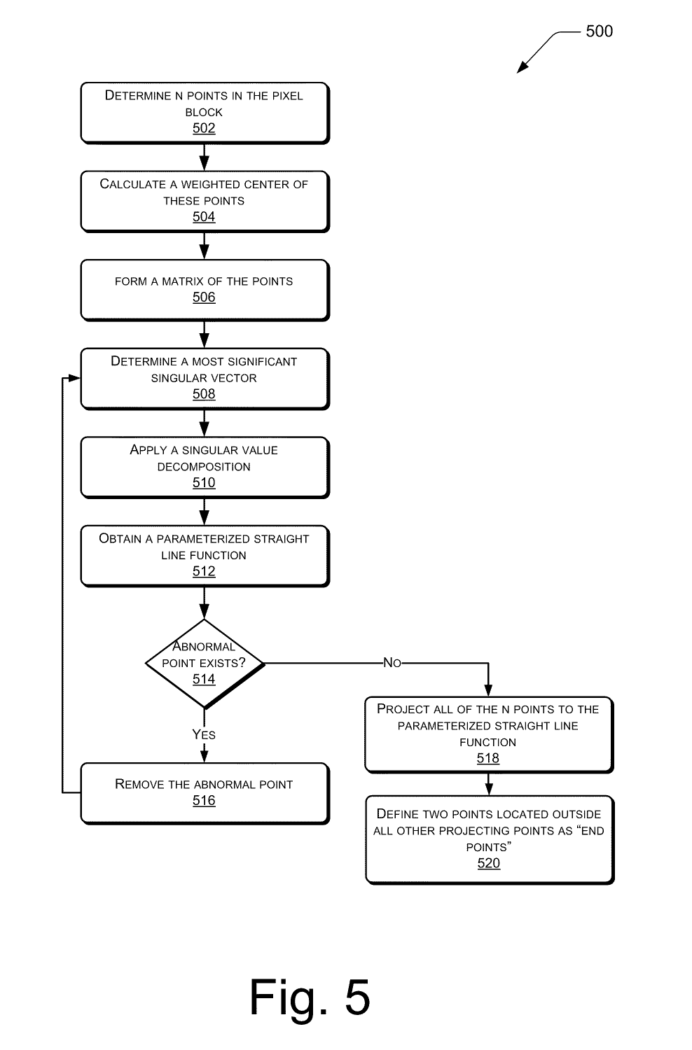

FIG. 3 shows an illustrative process 300 of parallel block compression with a GPU that may, but need not, be implemented using the architecture shown in FIGS. 1-2. The process 300 (as well as processes 400 in FIGS. 4 and 500 in FIG. 5) is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process will be described in the context of the architecture of FIGS. 1-2.

At block 302 the processor reads a 4×4 pixel block comprising original pixels from memory. This pixel block may be part of image 110. At block 304 the processor determines possible cases for compressing the block. For example, where BC6 is in use, 324 possible cases are available. At block 306 the processor loads at least one case into at least one GPU core for processing. However, in some implementations a plurality of cases may be loaded into a single GPU core for processing, or one case may be distributed across many cores.

At blocks 308(1)-(C) the cases are evaluated on the GPU cores. This evaluation comprises encoding the block and determining the difference between the original block and the encoded block for each case. This evaluation may include the following: At blocks 310(1)-(C) the GPU cores initialize the end points of the block and at blocks 312(1)-(C) optimizes the end points. Optimization of end points is described in more depth below with regards to FIG. 5.

At blocks 314(1)-(C) the GPU cores quantizes the end points, such as described in the specification of BC6. Quantization may comprise querying a lookup table or performing a calculation to take several values and reduce them to a single value. Quantization aids compression by reducing the number of discrete symbols to be compressed. For example, portions of an image may be quantized, which results in a loss of image data such as brightness or color palette. While lossy compression “loses” data which is intended by a designer to be insignificant or invisible to a user, these losses can accumulate and result in unwanted image degradation.

At blocks 316(1)-(C) the cores encode each of the 16 pixels in the 4×4 pixel block with end points. Pixels in a block may be represented as linear interpolates of end points. For example, with one dimensional data, if there are 2 end points: 0 and 0.5, four pixels 0, 0.2, 0.5, 0.1 are encoded to 0, 0.4, 1, 0.2, respectively. At blocks 318(1)-(C) the cores unquantize the ends points. Next, at blocks 320(1)-(C) the cores reconstructs all pixels of the block, and finally at blocks 322(1)-(C) the cores measures the reconstructed pixels relative to that of the original pixels, to determine the error. In one implementation, the error may be calculated as follows:

Σ{(R(r)−R(p))²+(G(r)−G(p))²+(B(r)−B(p))²}

where r is a reconstructed pixel, p is an original pixel, R(x), G(x), and B(x) return red, green, and blue component, respectively, of a pixel x. As mentioned above, block compression involves lossy compression, and selection of the compression case which minimizes this error reduces those adverse impacts such as image degradation.

Following the completion of the evaluation of 308(1)-(C), at blocks 324(1)-(C) the cores apply a parallel reduction to a plurality of results comprising (case identifier, error) to determine which case has the least error. Parallel reduction is described in more detail below with regards to FIG. 4. At blocks 326(1)-(C) the block is encoded using the least error case. In some implementations, the encoding may also include packing the result into unsigned integers suitable for further use by a graphics system.

Furthermore, in some implementations where sufficient memory exists within the GPU, state information resulting from the evaluation may be retained. Where such state retention is available, the least error case may be selected, and other non-least error cases may be discarded. Thus, because the block has previously been encoded during the evaluation and the output state stored, the encoding step 326 may be omitted and the stored output state used.

FIG. 4 is a flow diagram of an illustrative process 400 of parallel reduction of cases. Parallel reduction may be executed on the GPU cores 116, to allow for rapid sorting of case evaluation results to find the case with the least error. For illustrative purposes, and not by way of limitation, case evaluation results 402 are shown containing a number in the form (case number, error). For example, block (1,5) indicates case number 0 has a measured error of 5.

At 404, eight case evaluation results are shown: (1,5), (2,18), (3,7), (4,1), (5,2), (6,10), (7,12), (8,9). At 406, cases evaluation results are paired up. In one implementation, this pairing may take the form of c+(n/2), where c is the position of the case evaluation and n is the total number of case evaluation results. Thus, the first case evaluation result of (1,5) is paired with (5,2), (2,18) with (6,10), (3,7) with (7,12), and (4,1) with (8,9). At 408 the n/2 case evaluation results with the lowest errors are selected.

At 410, case evaluation results (5,2), (6,10), (3,7), (4,1) are selected as having the lowest errors, and are paired up 406 and selected 408 as described above. At 412, case evaluation results comprising (5,2) and (5,1) are shown. As above, the case evaluation result with the lowest error is selected 408. At 414, case evaluation result (4,1) is shown, which by the nature of having the lowest error, is determined to be used for encoding the block 416.

FIG. 5 is a flow diagram of an illustrative process 500 of optimizing endpoints in a block by applying a singular value decomposition (SVD) to find a straight line in 3D space to best approximate original end points. Because reconstructed pixel values are interpolated from end points, optimizing end points can help improve compression quality. While one implementation may use the maximum and minimum values of these pixels, another more accurate implementation exists and is described next.

Assume for this example that the input is 4 to 16 three-dimensional (3D) points, such as may be found in a block with texture data. Block 502 determines n 3D points in the pixel block, from p₁=(x₁₁ x₁₂ x₁₃) to pₙ=(xₙ₁ xₙ₂ xₙ₃) to process, where n varies from 4 to 16.

Block 504 calculates a weighted center v₀=(v₀₁ v₀₂ v₀₃) of the n 3D points. Next, block 506 forms matrix n×3 matrix by subtracting v₀ from all the points to get \hat{p}\hat{p₁}=\hat{x}\hat{x₁₁} \hat{x}\hat{x₁₂} \hat{x}\hat{x₁₃}) to pₙ=(\hat{x}\hat{xₙ₁} \hat{x}\hat{xₙ₂} \hat{x}\hat{xₙ₃}). These points are thus as follows:

$$M = [ \begin{matrix} & & \\ & & \\ … & … & … \\ & & \end{matrix} ]$$

Block 508 applies a compact SVD to M to determine the most significant singular vector v₁=(v₁₁ v₁₂ v₁₃) where

M=UΣV′

Here, U is a n×n matrix, V is a 3×3 matrix, Σ is a 3×3 diagonal matrix whose diagonal values decrease from left top to right bottom. v₁, is V′s first row.

Block 510 applies a SVD 510 to the most significant singular vector. Block 512 then obtains a parameterized straight line function L: v₀+αv₁ by combining the results from 510 with the weighted center v₀, where α is a variable that can be any real number. This line thus approximates the original points in an equation. However there may be some point located very far away from the straight line approximation which may lead to a poor approximation for all the other points.

To alleviate this problem, block 514 determines that when there is any point located 3 times an average distance from the line, it is an abnormal point. If such an abnormal point exists, block 516 removes the abnormal point and returns to 508 to determine a most significant vector. Even though error may increase slightly by iterating this process, better visual quality is often obtained. This is because not all of the points have a large fitting error. As the point number is small, it is assumed there is at most one abnormal point, thus the computation is done at most once in this implementation. However, in other implementations, the computation may be repeated to further reduce the error.

Block 518 projects all of the n points on to the line L. Block 520 selects the two points located outside all the other projecting points and defines these two points as end points. These end points may then be used in the block compression and decompression as describe above with regards to FIG. 3.

### CONCLUSION

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

What is claimed is:

1. One or more computer-readable storage media storing instructions that, when executed by a processor cause the processor to perform acts comprising:
accessing a pixel block comprising a plurality of original pixels;
determining a plurality of possible cases for compressing the pixel block;
evaluating the plurality of the possible cases in parallel by processing each of the possible cases on at least one of a plurality of graphics processing unit (GPU) cores;
determining a least error case from the evaluated plurality of possible cases; and
encoding the pixel block using the least error case.

2. The computer-readable storage media of claim 1, wherein the pixel block comprises texture data.

3. The computer-readable storage media of claim 1, wherein the determining the least error case comprises a parallel reduction of evaluated plurality of the possible cases.

4. The computer-readable storage media of claim 3, further comprising executing the parallel reduction on one or more of the plurality of GPU cores.

5. The computer-readable storage media of claim 1, wherein the evaluating comprises:
initializing a set of end points for the block;
optimizing the end points;
quantizing the end points;
encoding all pixels of the block with the end points;
unquantizing the end points;
reconstructing all pixels; and
measuring a variance between the original pixels and the reconstructed pixels.

6. The computer-readable storage media of claim 5, wherein the least error case is determined by
Σ{(R(r)−R(p))²+(G(r)−G(p))²+(B(r)−B(p))²}
wherein r is a reconstructed pixel, p is an original pixel, and R(x), G(x), and B(x) return red, green, and blue components, respectively, of a pixel x.

7. The computer-readable storage media of claim 5, wherein the optimizing comprises:
determining three-dimensional points in the pixel block comprising n points, wherein the points comprise p₁=(x₁₁ x₁₂ x₁₃) to pₙ=(xₙ₁ xₙ₂ xₙ₃);
calculating a weighted center v₀=(v₀₁ v₀₂ v₀₃) of these points;
subtracting v₀ from all the points to produce \hat{p}\hat{p₁}=(\hat{x}\hat{x₁₁} \hat{x}\hat{x₁₂} \hat{x}\hat{x₁₃}) to pₙ=(\hat{x}\hat{xₙ₁} \hat{x}\hat{xₙ₂} \hat{x}\hat{xₙ₃});
forming a matrix comprising:
$$M = [ \begin{matrix} & & \\ & & \\ … & … & … \\ & & \end{matrix} ]$$
determining a most significant singular vector v₁=(v₁₁ v₁₂ v₁₃) by applying a compact singular value decomposition to M such that M=UΣV′, wherein U is a n×n matrix, V is a 3×3 matrix, Σ is a 3×3 diagonal matrix whose diagonal values decrease from left top to right bottom;
applying a singular value decomposition to the matrix;
obtaining a parameterized straight line function L: v₀+αv₁ where α is any real number;
testing for an abnormal point located at three times an average distance from the parameterized straight line and when the abnormal point located at three times the average distance from the line exists, removing the point from M and determining a most significant singular vector;
projecting all of the n points to the line L; and
selecting two points located outside all other projecting points as end points.

8. A method comprising:
accessing a pixel block comprising a plurality of original pixels;
selecting a plurality of possible compression cases for compressing the pixel block;
evaluating at least a portion of the plurality of possible compression cases in parallel on a multi-core device;
determining a least error compression case from the evaluated plurality of possible compression cases; and
block compressing the pixel block with the least error case.

9. The method of claim 8, wherein the least error case is determined by
Σ{(R(r)−R(p))²+(G(r)−G(p))²+(B(r)−B(p))²}
wherein r is a reconstructed pixel, p is an original pixel, and R(x), G(x), and B(x) return red, green, and blue components, respectively, of a pixel x.

10. The method of claim 8, wherein the least error compression case comprises a compression case with the lowest error of all compression cases evaluated.

11. The method of claim 8, wherein the determining the least error compression case comprises parallel reduction of the evaluated plurality of possible compression cases on the multi-core device.

12. The method of claim 8, wherein the multi-core device comprises a graphics processing unit.

13. The method of claim 8, wherein the pixel block comprises 16 pixels.

14. The method of claim 8, wherein the compression cases further comprise partition cases.

15. A system to perform parallel block compression comprising:
a processor;
a memory coupled to the processor and configured to store an image comprising at least one pixel block;
a graphics processing unit (GPU) comprising a plurality of processor cores and coupled to the processor and memory;
a block compression module stored in the memory and configured to:
determine a plurality of cases for compressing the pixel block;
load each case into a core of the GPU for evaluation;
evaluate at least a portion of the plurality of cases in the GPU core in parallel;
measure the error of each of the plurality of cases; and
determine a least error case.

16. The system of claim 15, wherein the block compression module is further configured to load two or more cases into a single core of the GPU.

17. The system of claim 15, wherein the block compression module is further configured to encode the pixel block with the least error case.

18. The system of claim 15, wherein the block compression module is further configured to process a plurality of pixel blocks in parallel.

19. The system of claim 15, wherein parallel reduction executed on the GPU determines the least error case.

20. The system of claim 15, wherein the least error case is determined by
Σ{(R(r)−R(p))²+(G(r)−G(p))²+(B(r)−B(p))²}
wherein r is a reconstructed pixel, p is an original pixel, and R(x), G(x), and B(x) return red, green, and blue components, respectively, of a pixel x.
